(19) United States
(12) Patent Application Publication
(10) Pub. No.: US 2025/0340140 A1
(43) Pub. Date: Nov. 6, 2025

(54) INVERTER ACTIVE DISCHARGE THROUGH POWER MODULES FOR HIGH VOLTAGE SYSTEMS OF ELECTRIC VEHICLES

(71) Applicant: FCA US LLC, Auburn Hills, MI (US)

(72) Inventors: Daniel R. Luedtke, Beverly Hills, MI (US); Claudio Bruning, Royal Oak, MI (US)

(21) Appl. No.: 18/653,175

(22) Filed: May 2, 2024

(51) Int. Cl. B60L 53/22

(52) U.S. Cl. CPC B60L 53/22; B60L 2210/40

(57) ABSTRACT

An inverter active discharge technique for an electrified vehicle includes in response to detecting the discharge request, performing an active inverter discharge procedure including commanding one set of the set of upper switches and the set of lower switches of a three-phase inverter to each be in an ON state to cause a three-phase short across the three-phase inverter to prevent back electromotive force (EMF) from supporting a high voltage bus, wherein the three-phase inverter is configured to convert an input direct current (DC) voltage to output alternating current (AC) voltages for powering an electric motor of the electrified vehicle, and during the three-phase short, commanding the other set of the set of upper switches and the set of lower switches of the three-phase inverter according to a periodic pulse waveform to allow shoot-through current to quickly discharge the high voltage bus.

### FIELD

The present application generally relates to electrified vehicles and, more particularly, to techniques for inverter active discharge through power modules for high voltage systems of electrified vehicles.

### BACKGROUND

Some electrified vehicles include high voltage systems that use a three-phase inverter to convert high voltage direct current (DC) power to high voltage alternating current (AC) power to power electromagnetic coils of a three-phase electric motor. This high voltage system must be periodically discharged (e.g., to a desired level for electrical isolation, such as less than ˜60V) for various safety reasons. One example is during a crash scenario of the electrified vehicle where the high voltage system must be quickly discharged. Conventional solutions for discharging the high voltage system involve utilizing special additional systems or components (e.g., resistor banks and corresponding switches) for fast discharging of a high voltage bus. Such solutions, however, can drastically increase vehicle costs, packaging, and weight. Other solutions may also limit the speed of the electric motor, which is undesirable. Accordingly, while such conventional high voltage discharge systems do work for their intended purpose, there exists an opportunity for improvement in the relevant art.

### SUMMARY

According to one example aspect of the invention, an inverter active discharge system for an electrified vehicle is presented. In one exemplary implementation, the inverter active discharge system comprises a three-phase inverter comprising a set of upper switches and a set of lower switches configured to be controlled to convert an input direct current (DC) voltage from a high voltage bus of the electrified vehicle to output alternating current (AC) voltages for powering an electric motor of the electrified vehicle, and a control system configured to detect a discharge request to discharge the high voltage bus to a target DC voltage and, in response to detecting the discharge request, control the three-phase inverter to perform an active inverter discharge procedure including commanding one set of the set of upper switches and the set of lower switches of the three-phase inverter to each be in an ON state to cause a three-phase short across the three-phase inverter to prevent back electromotive force (EMF) from supporting the high voltage bus and, during the three-phase short, commanding the other set of the set of upper switches and the set of lower switches of the three-phase inverter according to a periodic pulse waveform to allow shoot-through current to quickly discharge the high voltage bus.

In some implementations, the control system is further configured to periodically alternate the sets of upper and lower transistors between (i) being commanded on to cause the three-phase short and (ii) being commanded according to the periodic pulse waveform. In some implementations, the control system is configured to control the periodic alternating between the sets of upper and lower switches to balance temperatures of the sets of upper and lower switches. In some implementations, the control system is further configured to change or reprogram deadtimes of gate drive integrated circuits (GDICs) associated with the three-phase inverter to further improve discharge performance.

In some implementations, the control system is further configured to change or reprogram desaturation thresholds of GDICs associated with the three-phase inverter to further improve discharge performance. In some implementations, the discharge request is generated in response to a crash event of the electrified vehicle. In some implementations, the discharge request is generated in response to a key-off or power-off event of the electrified vehicle. In some implementations, the electrified vehicle does not include a resistor bank for discharging the high voltage bus. In some implementations, the electrified vehicle does not include any additional components designed for discharging the high voltage bus.

According to another example aspect of the invention, an inverter active discharge method for an electrified vehicle is presented. In one exemplary implementation, the inverter active discharge method comprises detecting, by a control system of the electrified vehicle, a discharge request to discharge a high voltage bus of the electrified vehicle, wherein the electrified vehicle includes a three-phase inverter comprising a set of upper switches and a set of lower switches configured to be controlled to convert an input DC voltage from the high voltage bus to output AC voltages for powering an electric motor of the electrified vehicle and, in response to detecting the discharge request, performing, by the control system, an active inverter discharge procedure including commanding one set of the set of upper switches and the set of lower switches of the three-phase inverter to each be in an ON state to cause a three-phase short across the three-phase inverter to prevent back EMF from supporting the high voltage bus, and during the three-phase short, commanding the other set of the set of upper switches and the set of lower switches of the three-phase inverter according to a periodic pulse waveform to allow shoot-through current to quickly discharge the high voltage bus.

In some implementations, the active inverter discharge method further comprises periodically alternating, by the control system, the sets of upper and lower transistors between (i) being commanded on to cause the three-phase short and (ii) being commanded according to the periodic pulse waveform. In some implementations, the controlling of the periodic alternating between the sets of upper and lower switches is performed to balance temperatures of the sets of upper and lower switches. In some implementations, the active inverter discharge method further comprises to changing or reprogramming, by the control system, deadtimes of GDICs associated with the three-phase inverter to further improve discharge performance.

In some implementations, the active inverter discharge method further comprises changing or reprogramming, by the control system, desaturation thresholds of GDICs associated with the three-phase inverter to further improve discharge performance. In some implementations, the discharge request is generated in response to a crash event of the electrified vehicle. In some implementations, the discharge request is generated in response to a key-off or power-off event of the electrified vehicle. In some implementations, the electrified vehicle does not include a resistor bank for discharging the high voltage bus. In some implementations, the electrified vehicle does not include any additional components designed for discharging the high voltage bus.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIGS. 1A-1B are block and circuit diagrams of an electrified vehicle having and an example inverter active discharge system according to the principles of the present application;

FIG. 2 is a timing diagram of example control signals for inverter switches during an example active discharge procedure according to the principles of the present application; and

FIG. 3 is a flow diagram of an example inverter active discharge method for an electrified vehicle according to the principles of the present application.

### DESCRIPTION

As previously discussed, a high voltage system of an electrified vehicle must be capable of being quickly discharged (e.g., to a desired level for electrical isolation, such as less than ˜60V) for various safety reasons. Conventional solutions for discharging the high voltage system involve utilizing special additional systems or components (e.g., resistor banks and corresponding switches) for fast discharging of a high voltage bus. Such solutions, however, can drastically increase vehicle costs, packaging, and weight. Resistor bank based solutions, for example, are particularly expensive and heavy. Other solutions may also limit the speed of the electric motor, which is undesirable. Accordingly, improved techniques that perform inverter active discharge through existing power modules and without the need for the above-described additional systems/components are presented herein. These techniques involve initially causing a three-phase short (3PS) condition across the three-phase inverter by commanding all of a set of upper switches or all of a set of lower switches of the three-phase inverter to be held in an ON-state (e.g., all three upper or lower switches of a three-phase H-bridge inverter).

By commanding or causing the 3PS condition of the three-phase inverter, a back electromotive force (EMF) is prevented or mitigated from keeping the high voltage bus above a target voltage (e.g., less than ˜60V) while the electric motor is still spinning. Next, and during the 3PS condition, short on-pulses are applied to the complementary switches (upper or lower switches). This allows for partial shoot-through current across the three-phase inverter and fast discharging of the high voltage bus. The specific set of upper/lower switches that are fully-on (for the 3PS) can also be alternated in some manner to balance the heat generated and dissipated by the respective sets of upper/lower switches. In some implementations, gate drive integrated circuits (GDICs) associated with the three-phase inverter could be reprogrammed or their control could be changed to vary deadtimes and/or desaturation thresholds for even better (e.g., faster) discharge performance. Each of these GDICs is configured to generate a gate drive voltage based on a set of input signals (e.g., power, ground, and control).

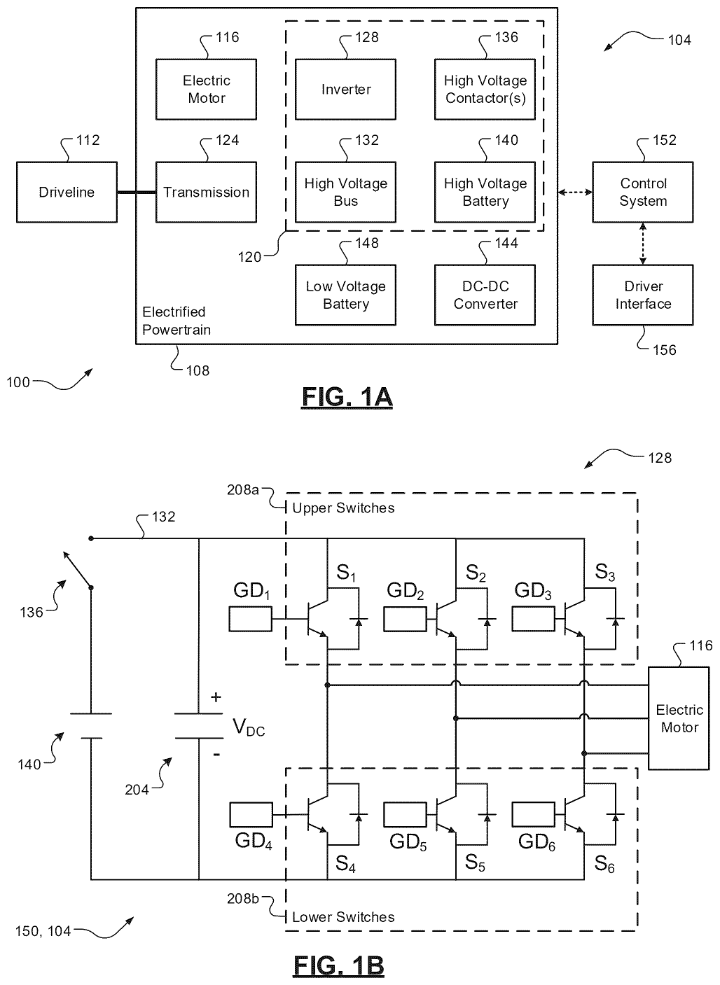

Referring now to FIG. 1A a functional block diagram of an electrified vehicle 100 having an example inverter active discharge system 104 according to the principles of the present application is illustrated. The electrified vehicle 100 generally comprises an electrified powertrain 108 configured to generate and transfer torque to a driveline 112 for vehicle propulsion. The electrified powertrain 108 includes at least one electric motor 116 (e.g., a three-phase electric traction motor) configured to generate drive torque using high voltage power provided by a high voltage system 120. The drive torque generated by the electric motor 116 is transferred to the driveline 112 via a transmission 124, such as a multi-speed automatic transmission or a continuously variably transmission (CVT). The high voltage system 120 comprises an inverter 128 (e.g., a three-phase traction inverter) configured to output alternating current (AC) voltages for powering respective electromagnetic coils (not shown) of the electric motor 116. It will be appreciated that the electrified powertrain 108 could include multiple electric motors and, in some implementations, other torque generating components, such as an internal combustion engine.

The inverter 128 is configured to receive a direct current (DC) input voltage from a high voltage bus 132, which is selectively connected to a high voltage battery pack or system 140 via one or more high voltage contactors 136. In some implementations, the electrified powertrain 108 further comprises a DC-DC converter 144 configured to selectively step-down the high voltage of the high voltage system 120 for supporting or recharging a low voltage battery pack or system 148 (e.g., a 12V lead-acid battery). A controller or control system 152 is configured to control operation of the electrified vehicle 100 including primarily controlling the electrified powertrain 108 to generate and transfer a desired amount of drive torque to the driveline 112 to satisfy a driver torque request. The driver torque request could be provided by a driver of the electrified vehicle 100 via a driver interface 156, such as an accelerator pedal or similar device. The electrified vehicle 100 could also include a plurality of sensors (not shown) configured to measure various operating parameters of the electrified vehicle 100 (speeds, temperatures, pressures, currents/voltages, etc.). The control system 152 is also configured to perform at least a portion of the inverter active discharge techniques of the present application.

Referring now to FIG. 1B, a circuit diagram of an example configuration 150 of the inverter active discharge system 104 according to the principles of the present application is illustrated. As shown, the high voltage battery 140 is selectively connected to the high voltage bus 132 via the one or more high voltage contactors 136. The inverter 128 receives a DC input voltage (V_{DC}) corresponding to a capacitor or capacitance 204. As shown, the inverter 128 has a three-phase H-bridge configuration with three upper switches or transistors S₁, S₂, and S₃ and three lower switches or transistors S₄, S₅, and S₆. In some implementations, each switch or transistor S₁-S₆ has a respective gate drive integrated circuit (GDICs) GD₁, GD₂, . . . , GD₆. Each GDIC receives power/ground signals and a control signal, such as a pulse-width modulated (PWM) control signal. The midpoint of each leg of the inverter 128 corresponds to a different AC voltage for powering the electric motor 116. In some implementations, the deadtime and/or desaturation thresholds of at least some of the GDICs GD₁-GD₆ can be changed or reprogrammed by the control system 152 to improve performance (e.g., speed) of the discharge of the high voltage bus 132.

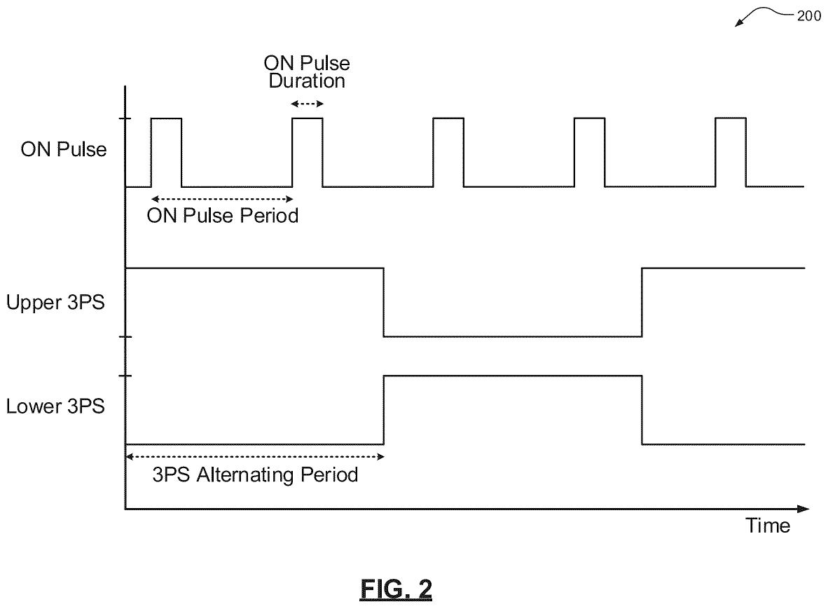

Referring now to FIG. 2, a timing diagram 200 of example control signals for inverter switches during an example active discharge procedure according to the principles of the present application is illustrated. As shown, the inverter 128 is alternatively controlled between an upper 3PS condition (where all three upper switches S₁-S₃ are commanded to an ON-state) and a lower 3PS condition (where all three lower switches S₄-S₆ are commanded to an ON-state). During these 3PS conditions, the other (complimentary) set of switches are periodically pulsed ON (for a much shorter duration compared to the entire 3PS period) to allow shoot-through currents that significantly decreases the voltage of the high voltage bus 132. The switches that are in 3PS (fully ON) will have saturated shoot-through current and thus positive temperature coefficient (PTC) behavior, which naturally self-balances current among parallel dies. The set that is pulsing ON, however, will be transitioning between linear (negative temperature coefficient, or NTC) and saturated (PTC) behavior and a mix of naturally unbalancing or balancing, and thus there need to alternate 3PS between uppers and lowers in some pattern throughout the active discharging process. Thus, the switches S₁-S₆ can be alternated between the upper 3PS and lower 3PS conditions while the other (complimentary) set of switches are periodically pulsed ON.

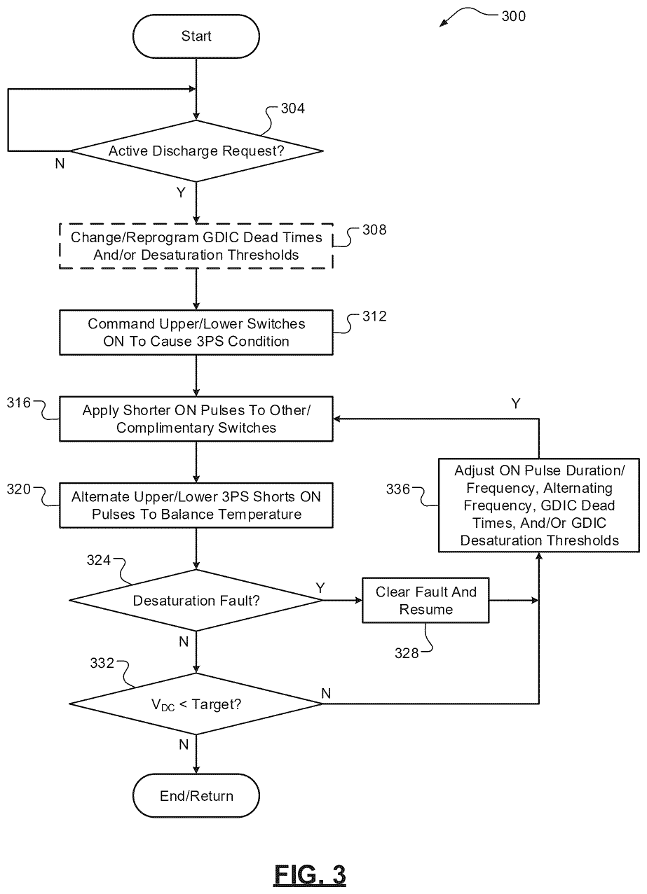

Referring now to FIG. 3, a flow diagram of an example inverter active discharge method 300 for an electrified vehicle according to the principles of the present application is illustrated. While the electrified vehicle 100 and its components are specifically referenced for descriptive/illustrative purposes, it will be appreciated that the method 300 could be applicable to any suitably configured electrified vehicle. At 304, the control system 152 determines whether an active discharge request is detected. This could be in response to, for example, detection of an imminent or beginning of a crash event or another suitable event such as on each key-off or power-off event of the electrified vehicle 100. When false, the method 300 ends or returns to 304. When true, the method 300 continues to 308 or 312. At optional 308, the control system 152 may change or reprogram the deadtimes and/or desaturation thresholds of at least some of the GDICs GD₁-GD₆ in an attempt to improve discharge performance (e.g., speed). At 312, the control system 152 commands the upper switches S₁-S₃ or the lower switches S₄-S₆ each to an ON-state to cause an upper or lower 3PS condition. At 316, during the 3PS condition, the control system 152 commands or applies shorter ON pulses to the other (complimentary) switches that are not being commanded for the 3PS condition.

At 320, the control system 152 alternates which of the upper/lower switches are being commanded ON for the 3PS condition and then also alternates which of the upper/lower switches are being pulsed ON to balance temperature between the upper/lower switches (e.g., to prevent overheating and potential damage thereto). At 324, the control system 152 determines whether a desaturation fault or malfunction has occurred at one of the switches/GDICs. When true, the method 300 proceeds to 328 where the fault or malfunction is cleared and active discharging continues and the method 300 then proceeds to 336. When false, the method 300 proceeds to 332 where the control system 152 determines whether the voltage VDC is less than a target (e.g., ˜60V DC). When false, the method 300 returns to 336. When true, the method 300 ends or returns to 304 for another cycle. At 336, the control system 152 varies any of the ON pulse durations/frequencies, the upper/lower switch 3PS condition alternating frequency, the GDIC dead times, and/or the GDIC desaturation thresholds based on the difference of V_{DC} from the target and, if applicable, based on the previously-detected desaturation fault or malfunction. In other words, the control system 152 attempts to vary at least some of these parameters to improve the active discharge performance (e.g., speed up the discharging of the high voltage bus 132).

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An inverter active discharge system for an electrified vehicle, the inverter active discharge system comprising:
a three-phase inverter comprising a set of upper switches and a set of lower switches configured to be controlled to convert an input direct current (DC) voltage from a high voltage bus of the electrified vehicle to output alternating current (AC) voltages for powering an electric motor of the electrified vehicle; and
a control system configured to detect a discharge request to discharge the high voltage bus to a target DC voltage and, in response to detecting the discharge request, control the three-phase inverter to perform an active inverter discharge procedure including:
commanding one set of the set of upper switches and the set of lower switches of the three-phase inverter to each be in an ON state to cause a three-phase short across the three-phase inverter to prevent back electromotive force (EMF) from supporting the high voltage bus; and
during the three-phase short, commanding the other set of the set of upper switches and the set of lower switches of the three-phase inverter according to a periodic pulse waveform to allow shoot-through current to quickly discharge the high voltage bus.

2. The inverter active discharge system of claim 1, wherein the control system is further configured to periodically alternate the sets of upper and lower transistors between (i) being commanded on to cause the three-phase short and (ii) being commanded according to the periodic pulse waveform.

3. The active inverter discharge system of claim 2, wherein the control system is configured to control the periodic alternating between the sets of upper and lower switches to balance temperatures of the sets of upper and lower switches.

4. The active inverter discharge system of claim 1, wherein the control system is further configured to change or reprogram deadtimes of gate drive integrated circuits (GDICs) associated with the three-phase inverter to further improve discharge performance.

5. The active inverter discharge system of claim 1, wherein the control system is further configured to change or reprogram desaturation thresholds of gate drive integrated circuits (GDICs) associated with the three-phase inverter to further improve discharge performance.

6. The active inverter discharge system of claim 1, wherein the discharge request is generated in response to a crash event of the electrified vehicle.

7. The active inverter discharge system of claim 1, wherein the discharge request is generated in response to a key-off or power-off event of the electrified vehicle.

8. The active inverter discharge system of claim 1, wherein the electrified vehicle does not include a resistor bank for discharging the high voltage bus.

9. The active inverter discharge system of claim 1, wherein the electrified vehicle does not include any additional components designed for discharging the high voltage bus.

10. An inverter active discharge method for an electrified vehicle, the inverter active discharge method comprising:
detecting, by a control system of the electrified vehicle, a discharge request to discharge a high voltage bus of the electrified vehicle, wherein the electrified vehicle includes a three-phase inverter comprising a set of upper switches and a set of lower switches configured to be controlled to convert an input direct current (DC) voltage from the high voltage bus to output alternating current (AC) voltages for powering an electric motor of the electrified vehicle; and
in response to detecting the discharge request, performing, by the control system, an active inverter discharge procedure including:
commanding one set of the set of upper switches and the set of lower switches of the three-phase inverter to each be in an ON state to cause a three-phase short across the three-phase inverter to prevent back electromotive force (EMF) from supporting the high voltage bus; and
during the three-phase short, commanding the other set of the set of upper switches and the set of lower switches of the three-phase inverter according to a periodic pulse waveform to allow shoot-through current to quickly discharge the high voltage bus.

11. The inverter active discharge method of claim 10, further comprising periodically alternating, by the control system, the sets of upper and lower transistors between (i) being commanded on to cause the three-phase short and (ii) being commanded according to the periodic pulse waveform.

12. The active inverter discharge method of claim 11, wherein the controlling of the periodic alternating between the sets of upper and lower switches is performed to balance temperatures of the sets of upper and lower switches.

13. The active inverter discharge method of claim 10, further comprising to changing or reprogramming, by the control system, deadtimes of gate drive integrated circuits (GDICs) associated with the three-phase inverter to further improve discharge performance.

14. The active inverter discharge method of claim 10, further comprising changing or reprogramming, by the control system, desaturation thresholds of gate drive integrated circuits (GDICs) associated with the three-phase inverter to further improve discharge performance.

15. The active inverter discharge method of claim 10, wherein the discharge request is generated in response to a crash event of the electrified vehicle.

16. The active inverter discharge method of claim 10, wherein the discharge request is generated in response to a key-off or power-off event of the electrified vehicle.

17. The active inverter discharge method of claim 10, wherein the electrified vehicle does not include a resistor bank for discharging the high voltage bus.

18. The active inverter discharge method of claim 10, wherein the electrified vehicle does not include any additional components designed for discharging the high voltage bus.
